(19) United States
(12) Patent Application Publication
(10) Pub. No.: US 2011/0082950 A1
(43) Pub. Date: Apr. 7, 2011

(54) COMPUTER SYSTEM AND COMPUTER SYSTEM INPUT/OUTPUT METHOD

(75) Inventors: Hiroshi MINE, Yokohama (JP); Tadashi Takeuchi, Tokyo (JP); Ken Nomura, Yokohama (JP); Damien Le Moal, Machida (JP)

(73) Assignee: HITACHI, LTD.

(21) Appl. No.: 12/895,169

(22) Filed: Sep. 30, 2010

(30) Foreign Application Priority Data
Oct. 7, 2009 (JP) 2009-232958

(51) Int. Cl. G06F 3/00

(52) U.S. Cl. 710/36

(57) ABSTRACT

Under the environment where a storage system is virtualized by Thin Provisioning technology or the like, it is difficult to statically estimate the I/O characteristics of the entire virtual volume, causing a problem that the effect of input/output control by a computer cannot be fully achieved by I/O scheduling that is based on the characteristics of a virtual volume unit. To solve the above problem, the computer system of the present invention acquires characteristics information of a storage apparatus in which there exists an actual storage area corresponding to a virtual volume storage area that is the access target when accessing the virtual volume, divides an I/O request with respect to the virtual volume by storage apparatus in a case where the I/O request spans multiple storage apparatuses, carries out I/O scheduling based on the acquired actual area characteristics information, and issues the I/O request directly to the storage apparatus in accordance with the I/O scheduling result.

### BACKGROUND OF THE INVENTION

1. Field of the Invention

The present invention relates to technology for enhancing computer input/output performance with respect to a virtualized storage apparatus.

2. Description of the Related Art

A computer system in which a computer is coupled to a storage apparatus, and data input/output (I/O) is carried out from the computer to the storage apparatus over a network, has been commercialized. The network that connects this computer and storage apparatus is called a SAN (Storage Area Network), and FC (Fibre Channel) or iSCSI (Internet Small Computer System Interface) is the communication protocol used between the apparatuses.

Japanese Patent Application Laid-open No. 2003-316616 discloses a computer system, which collectively provides storage areas divided up among multiple storage apparatuses in a SAN environment as a single virtual volume (a virtual volume) to a computer. In addition, Japanese Patent Application Laid-open No. 2009-43055 describes a technology called Thin Provisioning, which dynamically allocates an actual storage area to the virtual volume. In Thin Provisioning technology, when providing a computer with a virtual volume that has a larger capacity than the actual storage area of the storage apparatus allocated initially, it is possible to prevent future over provisioning, i.e., the allocation of surplus actual storage areas to the virtual volume, by adding an actual storage area to be allocated to the virtual area in accordance with the actual usage status.

Furthermore, Japanese Patent Application Laid-open No. H9-160729 discloses technology for enhancing the data transfer processing speed in a disk array apparatus, which comprises multiple HDDs (Hard Disk Drives) or other such disk devices, by performing I/O scheduling for rearranging the execution sequence of external I/O requests based on the seek times or the like of the respective HDDs.

A virtual volume that is provided in accordance with the above-mentioned virtualization technology may be comprised from the storage areas of multiple storage apparatuses. Under the Thin Provisioning environment in particular, the storage area of a virtual volume may be granularly distributed and arranged in the actual storage areas of multiple storage apparatuses in provisioning block units. Therefore, the contiguous area of the virtual volume as seen from the computer may be noncontiguous areas of multiple storage apparatus storage areas, and a sequential access from the computer with respect to the virtual volume may be a random access with respect to the multiple storage apparatuses that make up the virtual volume. In addition, the storage apparatuses that make up the virtual volume need not be homogenous, and a single virtual volume may be comprised from multiple storage apparatuses having different characteristics, such as data transfer bandwidth and IOPS (Input Output Per Second), and the I/O characteristics with respect to the virtual volume may differ by provisioning block unit.

Under a virtualized storage environment such as this, it is difficult to statically estimate the I/O characteristics of the entire virtual volume, and differences will occur in the I/O characteristics in accordance with the area to be accessed even for an I/O-based access to a single virtual volume. Therefore, when carrying out input/output control to enhance real-time capabilities and make data transfer processing more efficient in a computer, the problem is that the accuracy of an estimate, such as an I/O execution time, decreases for I/O scheduling that is based on the characteristics of a virtual volume unit, preventing input/output control from achieving its full effect.

### SUMMARY OF THE INVENTION

To solve for this problem, an object of the present invention is to provide a method and apparatus for enhancing I/O performance by increasing the accuracy of computer I/O scheduling with respect to a virtualized storage apparatus that provides a virtual volume.

To achieve this object, the present invention acquires characteristic information of a storage apparatus in which there exists an actual storage area corresponding to a virtual volume storage area that is the access target when accessing the virtual volume, divides an I/O request by storage apparatus in a case where the I/O request with respect to the virtual volume spans multiple storage apparatuses, carries out I/O scheduling based on the acquired actual area characteristic information, and issues the I/O request directly to the storage apparatus in accordance with the I/O scheduling result.

In accordance with the present invention, it is possible to provide a method and apparatus, which can increase the accuracy of I/O scheduling in a computer under a storage virtualization environment that utilizes Thin Provisioning technology, and, in addition, enhance computer I/O performance with respect to a virtualized storage apparatus.

### BRIEF DESCRIPTION OF THE DRAWINGS

FIG. 1 is a diagram showing the configuration of a computer system;

FIG. 2 is a diagram showing the configuration of a computer 100;

FIG. 3 is a diagram showing the configuration of a virtualization apparatus 200;

FIG. 4 is a diagram showing the configuration of a storage apparatus 300;

FIG. 5 is a diagram showing detailed provisioning information 220;

FIG. 6 is a block diagram showing detailed virtual volume configuration information 221;

FIG. 7 is a diagram showing detailed virtual volume information 222;

FIG. 8 is a diagram showing detailed mapping information 223;

FIG. 9 is a diagram showing detailed physical volume usage status information 224;

FIG. 10 is a diagram showing detailed storage apparatus characteristic information 230;

FIG. 11 is a diagram showing an inter-apparatus message 500 in detail;

FIG. 12 is a diagram showing the modular configuration of an I/O scheduler 130;

FIG. 13 is a diagram showing a flowchart of a virtual I/O receiving process of the I/O scheduler 130;

FIG. 14 is a diagram showing a flowchart of an actual I/O issuing process of the I/O scheduler 130;

FIG. 15 is a diagram showing a flowchart of a virtual I/O response process of the I/O scheduler 130;

FIG. 16 is a diagram showing a flowchart of a virtual I/O conversion process of the virtualization apparatus 200;

FIG. 17 is a diagram showing the configuration of a computer system of a second example; and

FIG. 18 is a diagram showing the configuration of a computer system of a third example.

### DESCRIPTION OF THE PREFERRED EMBODIMENTS

The best mode for carrying out the present invention will be explained below using the drawings. Furthermore, the same reference signs will be assigned to the same components in the respective drawings, and explanations thereof will be omitted.

### Example 1

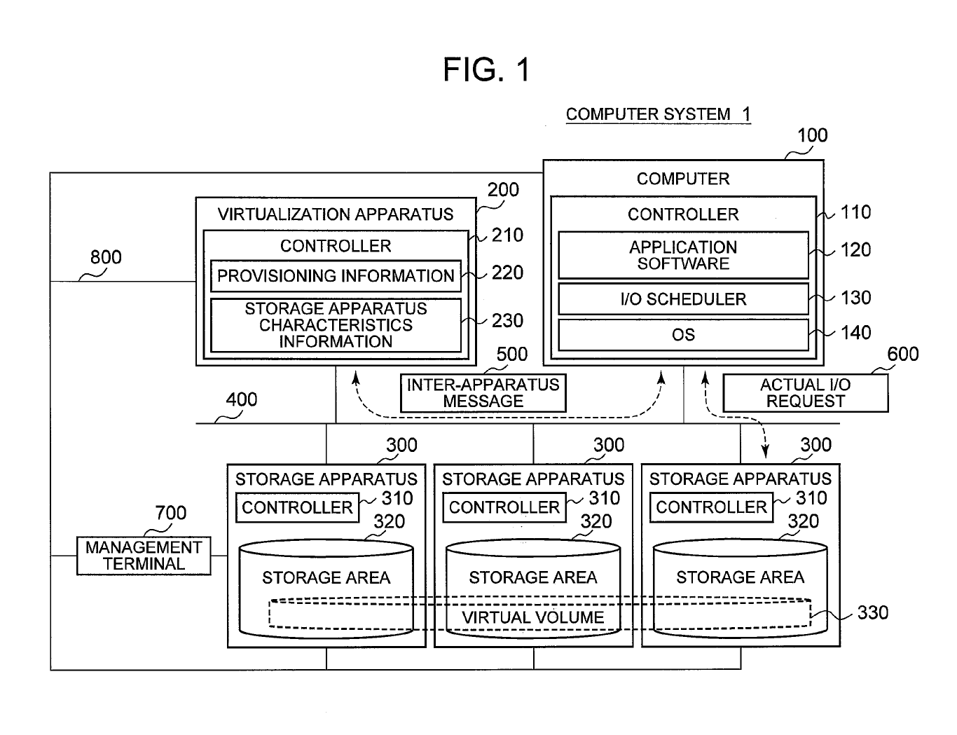

FIG. 1 is a diagram showing the configuration of a computer system of a first example. A computer system of this example comprises a computer 100, a virtualization apparatus 200, and a storage apparatus 300, which are respectively coupled to one another by a network 400 and a management network 800.

The computer 100 comprises a controller 110. The controller 110 controls the operation of the computer 100. Application software 120, an I/O scheduler 130, and an OS (Operating System) 140 run on the controller 110. The computer 100 provides a service to the user of this system using the application software 120.

The virtualization apparatus 200 comprises a controller 210. The controller 210 controls the operation of the virtualization apparatus 200. Provisioning information 220 and storage apparatus characteristic information 230 are stored in the controller 210. The virtualization apparatus 200 uses the storage apparatus 300 to provide a virtualization function to the computer 100.

The storage apparatus 300 comprises a controller 310 and a storage area 320. The controller 310 controls the operation of the storage apparatus 300. The storage apparatus 300 provides the computer 100 with either all or a portion of the storage areas 320 as a physical volume. A virtual volume 330, which is provided to the computer 100 in accordance with the virtualization function of the virtualization apparatus 200, is configured from a physical volume of the storage areas 320 of multiple storage apparatuses 300.

The network 400, for example, is configured from a SAN, a LAN (Local Area Network), a WAN (Wide Area Network), or a combination of these. The computer 100 communicates an inter-apparatus message 500 to the virtualization apparatus 200 via the network 400, and uses the virtualization function of the storage apparatus 300 providing the virtualization apparatus 200. The computer 100 also communicates an actual I/O request 600 to the storage apparatus 300 via the network 400, and accesses data stored in the storage area 320 of the storage apparatus 300.

A management terminal 700 holds the configuration information of each storage apparatus 300, and sends/receives the configuration information to/from the computer and virtualization apparatus via the management network 800.

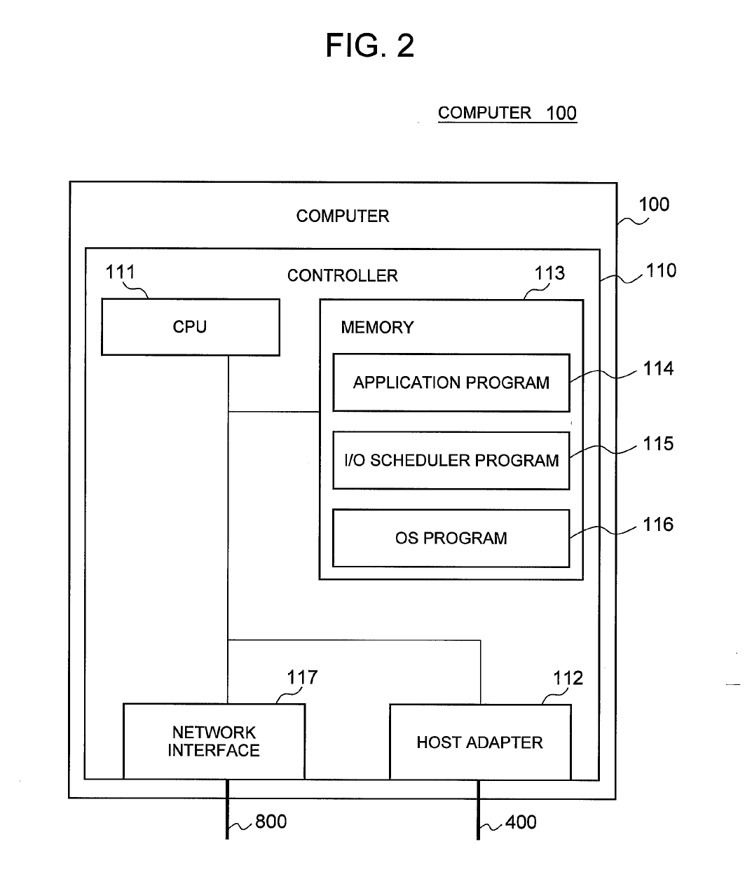

FIG. 2 is a block diagram of the computer 100. The controller 110 comprises a CPU (Central Processing Unit) 111, a host bus adapter 112, and a memory 113. The computer 100 further comprises input-output means, such as a display and a keyboard.

The CPU 111 controls the computer 100 and provides a service to the user by executing a program that is in the memory 113.

The host bus adapter 112 is an interface for coupling to the network 400, and is used in a SAN or other such FC connection. Furthermore, the present invention is not limited to a FC connection, but rather also enables the use of a NIC (Network Interface Card), and an Infiniband or the like for a LAN, WAN or other such IP (Internet Protocol) connection.

A network interface 117 is coupled to the management network 800, and is used to send/receive management information between the virtualization apparatus 200 and the storage apparatus 300, and in this example, a NIC is used, but another interface may also be used. In this example, the network interface 117 is used to carry out an out-of-band coupling, but the present invention is not limited to this, and an in-band coupling for sending/receiving configuration information using the host bus adapter 112 may be utilized.

The memory 113 is a RAM (Random Access Memory) or other such storage area, and stores an application program 114, an I/O scheduler program 115, and an OS program 116. These programs are stored as execution files in a ROM (Read Only Memory) or other such nonvolatile storage area or built-in HDD of the computer 100, or in a storage area 320 of the storage apparatus 300, and are read into the memory 113 when the computer 100 is booted up.

The application program 114 is for realizing the application software 120, and, for example, may be a streaming server program that provides a video delivery service, a DBMS (Data Base Management Service System) program that provides a database service, or a backup program that provides a backup service. The properties of the I/O requests issued by these programs, for example, may be such that a deadline is set for a streaming server program I/O request for reading video data, and an I/O request that does not end by the deadline is destroyed without delivering the video, and the priority level of a backup service I/O request is low and the backup service I/O request may be postponed until after an I/O request from another program, such as the DBMS program.

The I/O scheduler program 115 is for realizing the I/O scheduler 130. The configuration and operation of the I/O scheduler 130 will be described in detail further below.

The OS program 116 is for realizing the OS 140. The OS 140 comprises a device driver for controlling the host bus adapter 112, a communication protocol stack for controlling communications with the virtualization apparatus 200 and the storage apparatus 300, and a process scheduler for controlling the execution of the application software 120, and provides basic functions for controlling the computer 100.

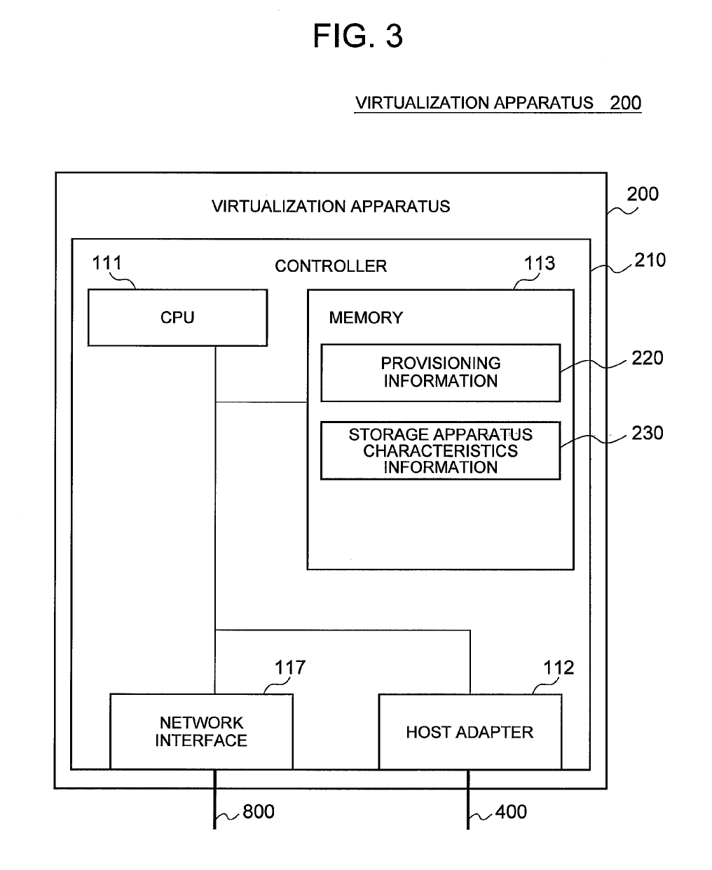

FIG. 3 is a block diagram of the virtualization apparatus 200. Basically, the configuration is the same as that of the computer 100, but the virtualization apparatus 200 differs from the computer 100 in that provisioning information 220 and storage apparatus characteristic information 230 are stored in the memory 113 as programs. The provisioning information 220 and the storage apparatus characteristic information 230 will be explained in detail further below.

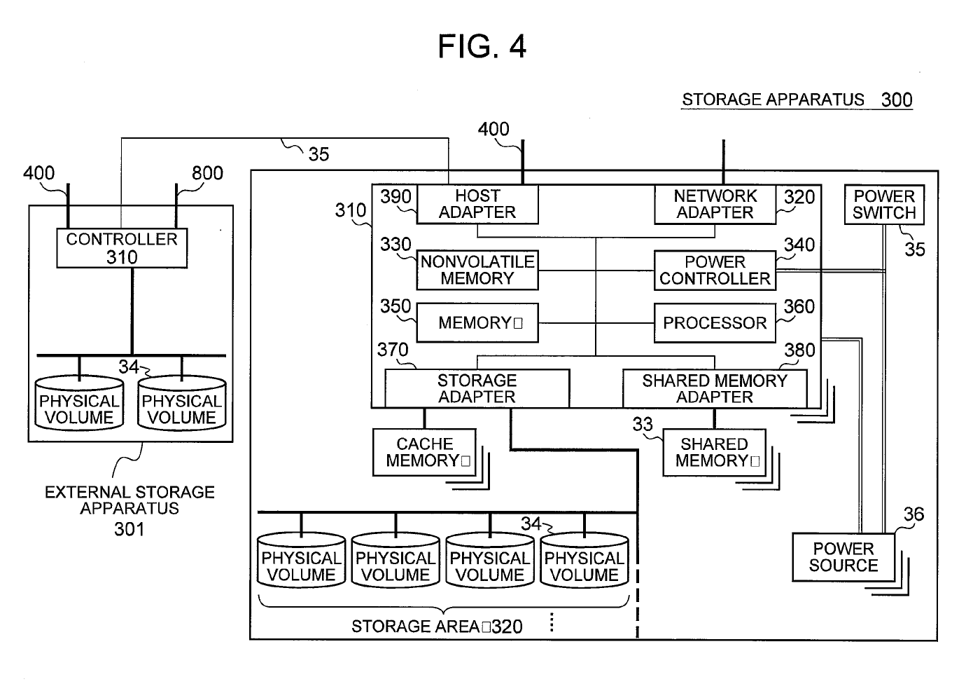

FIG. 4 is a block diagram of the storage apparatus 300. The storage apparatus 300 comprises the controller 310, a cache memory 32, a shared memory 33, a physical volume 34, a power switch 35, and a power source 36. The physical volume 34, for example, is a HDD, a SSD (Solid State Drive) or other such storage apparatus. As for the HDD, a FC, a SATA (Serial Advanced Technology Attachment), a PATA (Parallel Advanced Technology Attachment), and a SAS (Serial Attached SCSI) HDD can be used. In the case of the SSD, too, a SLC (Single Level Cell) or MLC (Multi Level Cell) type can be used, as well as an SSD that uses a semiconductor storage device. The controller 310 stores data in accordance with either a stand-alone configuration, or a RAID (Redundant Arrays of Inexpensive/Independent Disks) configuration in accordance with multiple physical volumes. The cache memory 32 temporarily stores data that is to be written to or has been read from the physical volume 34. The shared memory 33 stores configuration information of the controller 310 and the physical volume 34. The physical volume 34 provides a storage area 320 to the computer 100 and the virtualization apparatus 200. The power source 36 supplies power to the respective components of the storage apparatus 300. The power switch 35 is for controlling the supply of power from the power source 36.

The controller 310 comprises a host adapter 390, a network adapter 320, a nonvolatile memory 330, a power controller 340, a memory 350, a processor 360, a storage adapter 370, and a shared memory adapter 380.

The host adapter 390 sends and receives data between the computer 100 and the virtualization apparatus 200 via a storage network 50. The network adapter 320 sends and receives data between the computer 100 and the virtualization apparatus 200 via the management network 800.

The nonvolatile memory 330 comprises a hard disk or a flash memory, and stores a program and configuration information operated on by the controller 310. The power controller 340 controls the power that is supplied from the power source 36.

The memory 350, for example, comprises a RAM or the like, and stores a program, data and the like. The processor 360 reads a program that is stored in the nonvolatile memory 330 into the memory 350, and executes a process prescribed by the program.

The storage adapter 370 sends and receives data between the physical volume 34 and the cache memory 32.

An external storage apparatus 301 is coupled to the storage apparatus 300 either directly via a Fibre Channel or other such communication line 37, or via the network 400. The storage apparatus 300 is able to use the physical volume 34 of the external storage apparatus 301 the same as the in-apparatus physical volume 34.

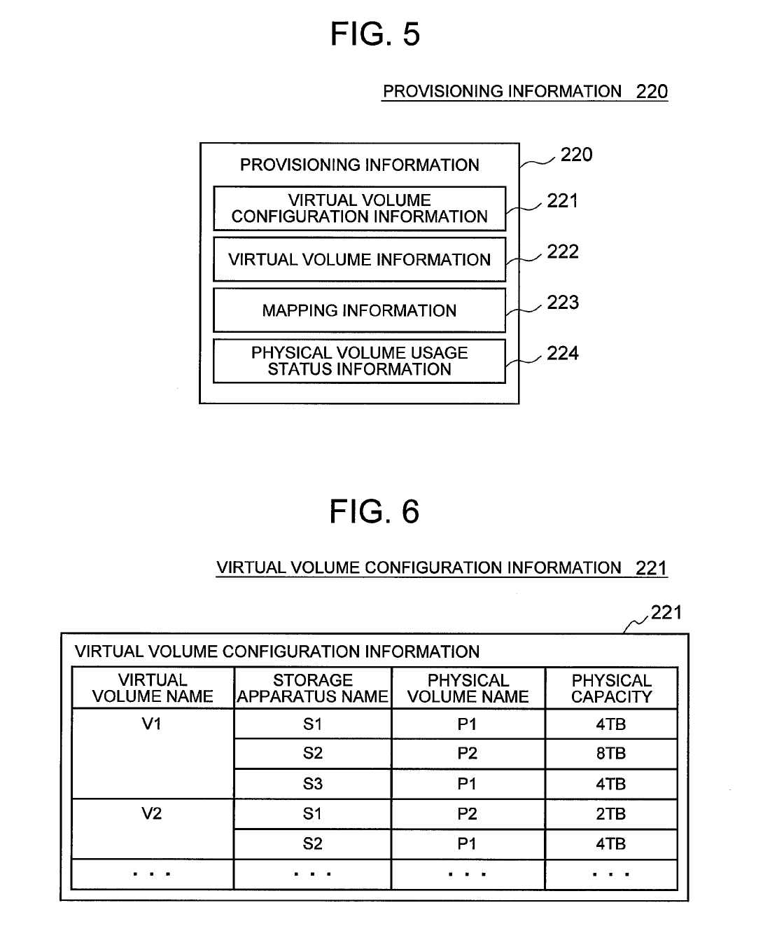

FIG. 5 is a diagram showing the provisioning information 220 stored on the controller 210 of the virtualization apparatus 200 in detail. The provisioning information 220 comprises virtual volume configuration information 221, virtual volume information 222, mapping information 223, and physical volume usage status information 224. A Thin Provisioning program on the controller 210 uses this information to provide the computer 100 with a virtual volume 330 that virtualizes the storage area 320 on the storage apparatus 300.

FIG. 6 is a diagram showing detailed virtual volume configuration information 221. The virtual volume configuration information 221 comprises a virtual volume name, a storage apparatus name, a physical volume name, and a physical capacity. The virtual volume name and the physical volume name here are IDs for identifying the volumes, and, for example, are associated with a LU (Logical Unit) number. Similarly, the storage apparatus name is an ID for identifying the storage apparatus 300, and, for example, is associated with a WWN (World Wide Name) in the case of an FC connection, and is associated with an IP address in the case of an IP connection. The physical capacity is the capacity of the physical volume identified by the storage apparatus name and the physical volume name.

The administrator of this system creates a virtual volume 330 by adding a new virtual volume name, plus the storage apparatus name and the physical volume name for configuring same to the virtual volume configuration information 221. The administrator is also able to expand the physical capacity of the virtual volume 330 while the virtual volume 330 is in operation by adding a new physical volume specified by the storage apparatus name and the physical volume name.

In the example of this drawing, a virtual volume V1 comprises a physical volume P1 of a storage apparatus S1 having a 4 TB capacity, a physical volume P2 of a storage apparatus 32 having an 8 TB capacity, and a physical volume P1 of a storage apparatus S3 having a 4 TB capacity.

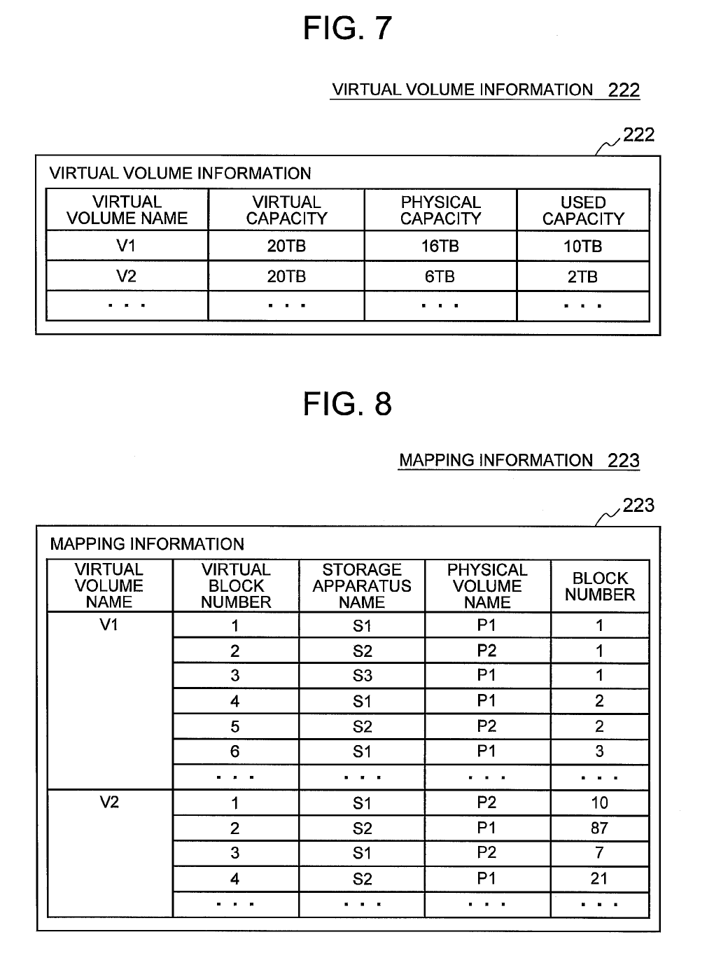

FIG. 7 shows detailed virtual volume information 222. The virtual volume information 222 comprises a virtual volume name, a virtual capacity, a physical capacity, and a used capacity. The virtual volume name corresponds to the virtual volume name of the virtual volume configuration information 221. The virtual capacity is the capacity of the virtual volume 330 shown to the computer 100, and the administrator sets this capacity when the virtual volume 330 is configured. The physical capacity is the total of the physical capacities of the physical volumes configuring the virtual volume 330. The used capacity shows the actual used capacity of the virtual volume 330, and is the same as the total of the used capacities of the physical volumes configuring the virtual volume 330.

In the example of this drawing, the virtual volume V1 has a virtual capacity of 20 TB, the physical capacity is 16 TB, and the actual used capacity is 10 TB.

FIG. 8 shows detailed mapping information 223. The mapping information 223 comprises a virtual volume name, a virtual block number, a storage apparatus name, a physical volume name, and a block number, and shows that the area specified by the virtual block number of the virtual volume 330 is actually arranged in a storage area 320 specified by the physical volume block number of the storage apparatus 300. The virtual block number and the block number here show the numbers of areas obtained by respectively segmenting the virtual volume 330 and the physical volume into the provisioning block size, for example, units of 64 KB from the beginning. Therefore, the maximum value of the virtual block number for each virtual volume 330 is the quotient obtained by dividing the virtual capacity of the corresponding virtual volume information 222 by the block size. Furthermore, a virtual block number, which has not been used, that is, which has not been accessed even once, may have an invalid value (for example, NULL) set in the storage apparatus name. A value obtained by multiplying the block size by the number of used virtual blocks constitutes the used capacity of the virtual volume information 222.

The example of this drawing shows that the virtual block number 1 area of the virtual volume V1 is arranged in the block number 1 area of the physical volume P1 of the storage apparatus S1.

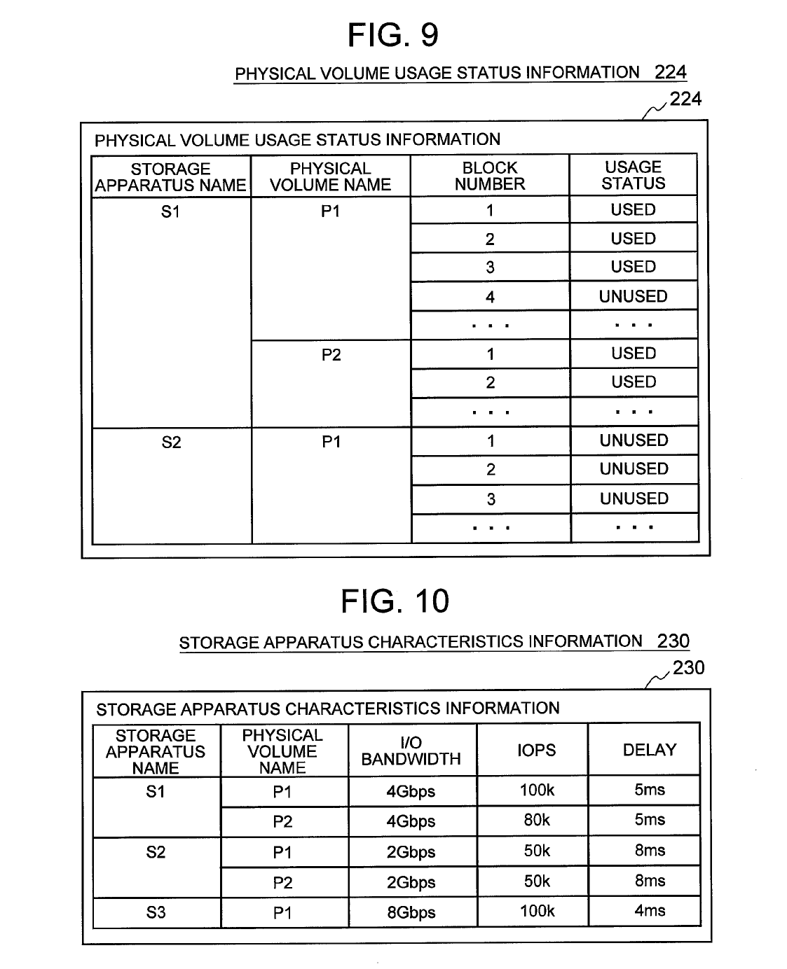

FIG. 9 shows detailed physical volume usage status information 224. The physical volume usage status information 224 comprises a storage apparatus name, a physical volume name, a block number, and a usage status, and shows the usage status of the physical volume specified by the storage apparatus name and the physical volume name in area provisioning block units. The maximum value of the block number for each physical volume is the quotient obtained by dividing the physical capacity of the corresponding virtual volume configuration information 221 by the block size. The area of the physical volume being used, that is, the usage status corresponding to the block number, which is described in the mapping information 223, is used.

The example of this drawing shows that the block number 1 area of the physical volume P1 of the storage apparatus S1 is used, but the block number 4 area is unused.

FIG. 10 is a diagram showing detailed storage apparatus characteristics information 230 stored in the controller 210 of the virtualization apparatus 200. The storage apparatus characteristics information 230 comprises a storage apparatus name, a physical volume name, an I/O bandwidth, an IOPS, and a delay, and shows the characteristics of the storage apparatus 300 and the physical volume. The I/O bandwidth and the IOPS here store the effective I/O bandwidth and the effective IOPS of the corresponding physical volume, and the delay stores the I/O request processing delay. The administrator may specify these values based on catalog values or the like when constructing the virtual volume 330, or may use the measured values obtained during an actual I/O access from the computer 100 to the storage apparatus 300. Furthermore, for example, the I/O bandwidth may serve as the link speed of the coupling port of the corresponding storage apparatus 300, and the two-way communication delay from the computer to the storage apparatus may be added to the delay.

The example of this drawing shows that the I/O bandwidth of the physical volume P1 of the storage apparatus S1 is 4 Gbps, the IOPS is 100 k, and the delay is 5 ms.

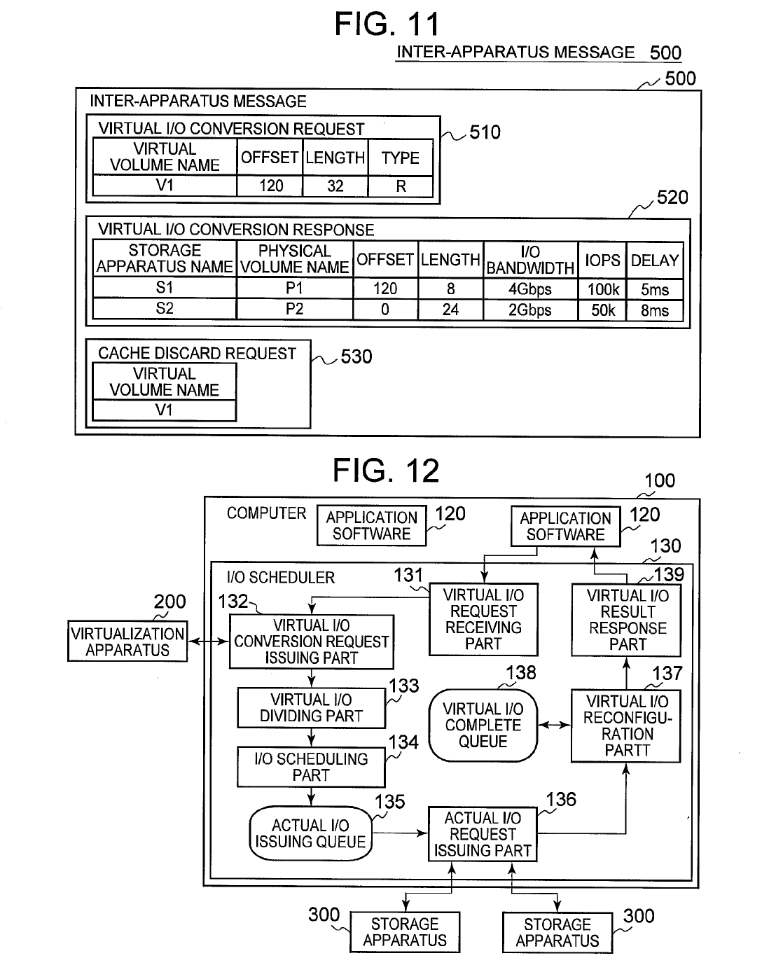

FIG. 11 shows the inter-apparatus message 500 in detail. Inter-apparatus messages 500 include a virtual I/O conversion request 510, a virtual I/O conversion response 520, and a cache discard request 530. The virtual I/O conversion request 510 is a message that is sent to the virtualization apparatus 200 from the computer 100, and is used for converting an I/O request with respect to the virtual volume 300 to the actual I/O request 600 with respect to the storage area 320 of the storage apparatus 300. The virtual I/O conversion response 520 is a message that is sent to the computer 100 from the virtualization apparatus 200, and is used as a response corresponding to the virtual I/O conversion request 510. The cache discard request 530 is a message that is sent to the computer 100 from the virtualization apparatus 200, and is used for the computer 100 to discard information on the corresponding virtual I/O conversion cached in the controller 110.

The virtual I/O conversion request 510 comprises a virtual volume name, an offset, a length, and a type. The virtual volume name is the identifier of the virtual volume 330 that constitutes the access target, and the offset and length show the range of the area of the virtual volume 330 to be accessed, for example, an LBA (Logical Block Address) in units of sector size and a number of sectors. The LBA and the number of sectors are processed inside the virtualization apparatus 200 by being converted to a virtual block number of the provisioning block size. The types include read R, write W, and clear C. In a case where the type is clear C, the area corresponding to the virtual volume 330, that is, the area of the physical volume that has been allocated thereto by the mapping information 223 is treated as unused. The example of this drawing shows that the virtual I/O conversion request 510 is a read access request with respect to the virtual volume V1, and is 32 sectors long from the offset of LBA 120.

The virtual I/O conversion response 520 comprises a storage apparatus name, a physical volume name, an offset, a length, an I/O bandwidth, an IOPS, and a delay. The storage apparatus name, the physical volume name, the offset, and the length here are determined by converting the area of the virtual volume 330 specified by the corresponding virtual I/O conversion request 510 to the corresponding physical volume area using the mapping information 223, and, in addition, the I/O bandwidth, the IOPS, and the delay are determined from the values stored in the storage apparatus characteristics information 230 of the corresponding physical volume. Furthermore, in a case where the area specified by the virtual I/O conversion request 510 extends across a provisioning block boundary, the virtual I/O conversion response 520 may store information on multiple physical volumes. The example of this drawing shows that the virtual I/O conversion response 520 comprises an 8-sector access from the offset of LBA 120 of the physical volume P1 of the storage apparatus S1, a 24-sector access from the offset of LBA 0 of the physical volume P2 of the storage apparatus S2, and the respective physical volume characteristics information.

The cache discard request 530 comprises a virtual volume name. In a case where the computer 100 receives a cache discard request 530, cached virtual I/O conversion information related to the virtual volume 330 corresponding to the virtual volume name is discarded. The cache discard request 530 is issued in a case where the virtualization apparatus 200, for example, has used shadow copy technology or the like to migrate the contents of the physical volume configuring the virtual volume 330 to another physical volume and has replaced the mapping information 223.

FIG. 12 is a diagram showing the modular configuration of the I/O scheduler 130 of the computer 100, and an overview of the operations of this example. The I/O scheduler 130 comprises a virtual I/O request receiving part 131, a virtual I/O conversion request issuing part 132, a virtual I/O dividing part 133, an I/O scheduling part 134, an actual I/O issuing queue 135, an actual I/O request issuing part 136, a virtual I/O reconfiguration part 137, a virtual I/O complete queue 138, and a virtual I/O result response part 139. The flow of processing of the I/O scheduler 130, as well as the operations of the respective modules will be explained below using flowcharts.

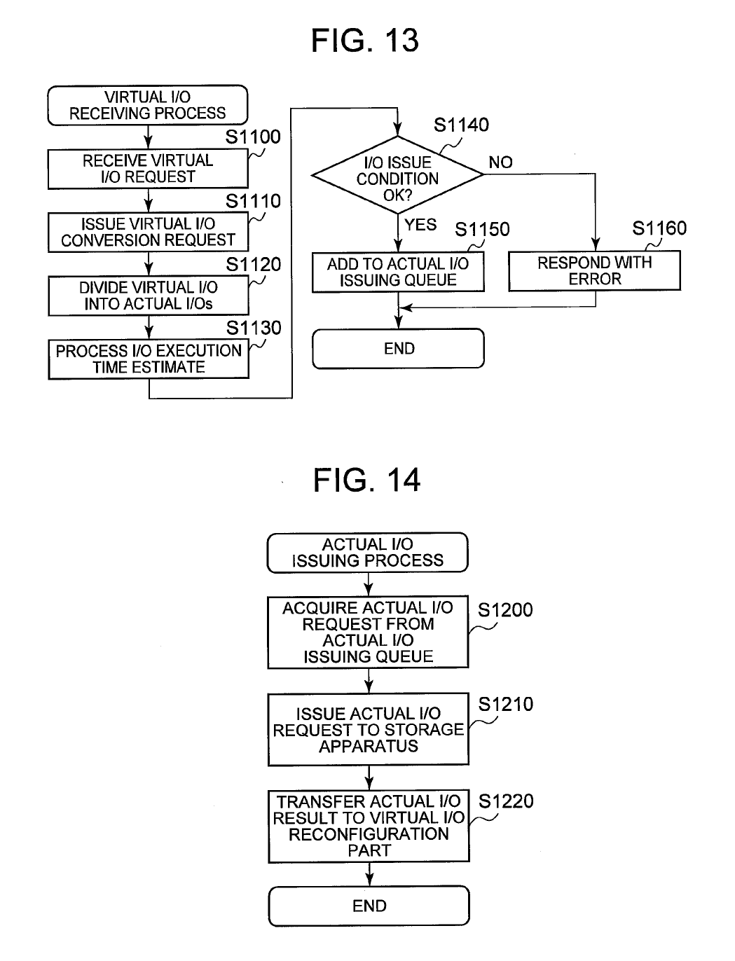

FIG. 13 is a diagram showing a flowchart of a virtual I/O receiving process of the I/O scheduler 130.

First, the virtual I/O request receiving part 131 receives a virtual I/O request with respect to the virtual volume 330 from the application software 120 (Step S1100). In a case where the application software 120 is a streaming server application and an I/O deadline must be taken into account at this time, the deadline is also received, and the deadline is associated with the virtual I/O request. In a case where the application software 120 is a DBMS application or the like and does not specify a deadline, the deadline for the virtual I/O request may be treated as indefinite. Furthermore, in a case where the application software 120 clearly specifies a priority, the priority is also received and is associated with the virtual I/O request. In a case where the application software 120 clearly does not specify a priority, the execution priority allocated to the application software 120 by the process scheduler inside the OS 140 may be used. Furthermore, a table comprising an execution filename and an I/O priority is managed inside the virtual I/O request receiving part 131, and when a virtual I/O request is received, the execution filename of the application software 120 that issued the virtual I/O request may be acquired from the OS 140, and a corresponding I/O priority may be determined from a table comprising the execution filename and the I/O priority. For example, in a case where a backup application matches the execution filename, the table stores a value that is the lowest I/O priority. The contents of this table may be incorporated beforehand in the I/O scheduler program 115 based on the execution filename of a widely used application software 120 and the properties thereof, or the administrator may set the table contents when configuring the computer 100. The virtual I/O request receiving part 131 transfers the received virtual I/O request to the virtual I/O conversion request issuing part 132 together with the deadline, the priority and other such information.

Next, the virtual I/O conversion request issuing part 132 creates a virtual I/O conversion request 510 from the virtual I/O request received from the virtual I/O request receiving part 131, and sends the created virtual I/O conversion request 510 to the virtualization apparatus 200 (Step S1110). The virtual I/O conversion request issuing part 132 receives the virtual I/O conversion response 520 from the virtualization apparatus 200 and transfers same to the virtual I/O dividing part 133 together with the virtual I/O request. At this point, the virtual I/O conversion request issuing part 132 may cache the content of the virtual I/O conversion response 520 in an internal storage area. In accordance with this, in a case where the received virtual I/O request already matches the area where the content is being cached, the virtual I/O conversion request issuing part 132 may create content equivalent to the virtual I/O conversion response 520 from the cached content, and may transfer same to the virtual I/O dividing part 133 without communicating with the virtualization apparatus 200. When caching is carried out, in a case where a cache discard request 530 has been received from the virtualization apparatus 200, the virtual I/O conversion request issuing part 132 discards the information related to the target virtual volume 330 from among the contents that are being cached.

Next, the virtual I/O dividing part 133 converts the virtual I/O request received from the virtual I/O conversion request issuing part 132 to an actual I/O request in accordance with the content of the virtual I/O conversion response 520 received from the same virtual I/O conversion request issuing part 132 (Step S1120). A single virtual I/O request may be divided into multiple actual I/O requests at this point. Information, such as the deadline, the priority, and the characteristics of the physical volume that constitutes the issue target are associated with the source virtual I/O request in the actual I/O request. The virtual I/O dividing part 133 transfers the converted actual I/O request to the virtual I/O scheduling part 134.

Next, the I/O scheduling part 134, for example, in a case where deadline scheduling is to be carried out with respect to the actual I/O request received from the virtual I/O dividing part 133, estimates the execution time of the new actual I/O request based on information, such as the I/O bandwidth, delay characteristics, and length of the physical volume that constitutes the issue target (Step S1130).

Next, the I/O scheduling part 134 determines whether or not the respective deadlines will be met while comparing same with the estimated execution time of an actual I/O request that is already in the actual I/O issuing queue 135 (Step S1140).

In a case where the deadline will be met (Step S1140: YES), the I/O scheduling part 134 adds the new actual I/O request to the actual I/O issuing queue 135 while rearranging the execution sequence of the actual I/O request inside the actual I/O issuing queue 135 as needed (Step S1150), and ends the processing. The I/O scheduling part 134, upon adding the actual I/O request to the actual I/O issuing queue 135, is able to enhance the I/O performance of the computer 100 by adding an execution schedule time based on the estimated execution time and the deadline, for example, such that the actual I/O request will be executed in parallel with an actual I/O request to a different storage apparatus 300.

In a case where the deadline will not be met, that is, when the new actual I/O request is compared to the actual I/O request that is already in the actual I/O issuing queue 135, for example, and it is estimated that the deadline will not be met due to an I/O bandwidth, IOPS overrun or the like in the target actual volume (Step S1140: NO), the I/O scheduling part 134 processes the source virtual I/O request as a missed deadline, and sends an error response to the application software 120 that issued the virtual I/O request without issuing the actual I/O request (Step S1160). This avoids affecting the actual I/O request that is already in the actual I/O issuing queue 135. Rather than processing the new actual I/O request as a missed deadline at this time, the I/O priority may be taken into account, and a low-priority actual I/O request of the actual I/O requests, which are already in the actual I/O issuing queue 135 and are targeted at the same physical volume, may be processed as a missed deadline instead.

FIG. 14 shows a flowchart of an actual I/O issuing process of the I/O scheduler 130.

First, the actual I/O request issuing part 136 fetches an actual I/O request from the actual I/O issuing queue 135 in execution sequence order (Step S1200).

Next, the actual I/O request issuing part 136 issues the fetched actual I/O request as the actual I/O request 600 directly to the storage apparatus 300 that has the targeted physical volume (Step S1210).

Lastly, the actual I/O request issuing part 136, upon receiving an actual I/O request result from the storage apparatus 300, transfers same to the virtual I/O reconfiguration part 137 as the actual I/O result (Step S1220), and ends the processing.

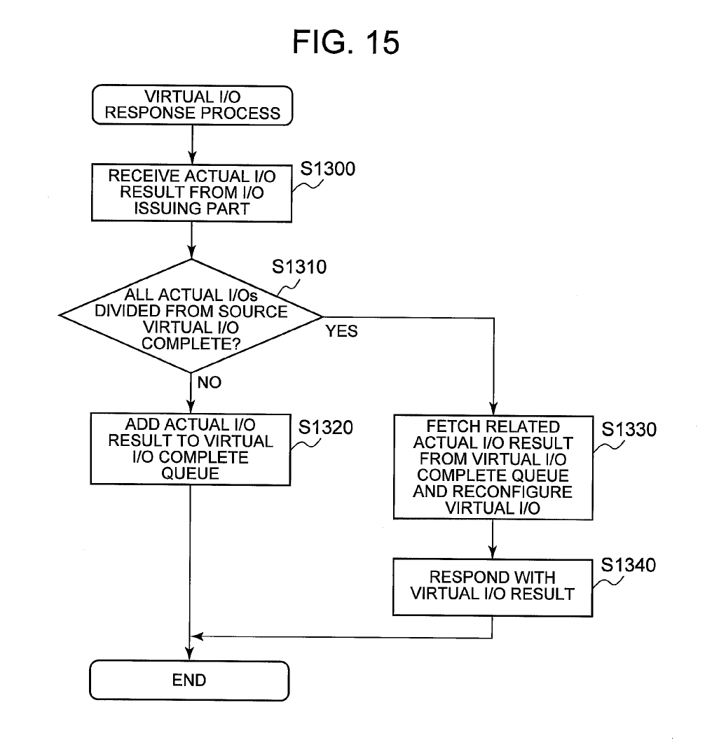

FIG. 15 shows a flowchart of a virtual I/O response process of the I/O scheduler 130.

First, the virtual I/O reconfiguration part 137 receives the actual I/O result from the actual I/O request issuing part 136 (Step S1300).

Next, the virtual I/O reconfiguration part 137 determines whether all of the actual I/O requests related to the source virtual I/O request in the received actual I/O result have been completed (Step S1310). In a case where the source virtual I/O request is divided into multiple actual I/O requests, the virtual I/O complete queue 138 is referenced at this point, and a check is performed as to whether all of the other actual I/O results related to the source virtual I/O request are stored.

In a case where there is an actual I/O request among the actual I/O requests related to the source virtual I/O request that has not been completed (Step S1310: NO), the virtual I/O reconfiguration part 137 adds the received actual I/O result to the virtual I/O complete queue 138 (Step S1320), and ends the processing.

In a case where all of the actual I/O requests related to the source virtual I/O request have been completed (Step S1310: YES), the virtual I/O reconfiguration part 137 fetches all the actual I/O results related to the source virtual I/O request from the virtual I/O complete queue 138, and together with the received actual I/O result, reconfigures same as the result of the source virtual I/O request (Step S1330). The virtual I/O reconfiguration part 137 transfers the reconfigured virtual I/O request results to the virtual I/O result response part 139.

Lastly, the virtual I/O result response part 139 responds to the application software 120 that issued the virtual I/O request with the results of the virtual I/O request received from the virtual I/O reconfiguration part 137 (Step S1340), and ends the processing.

According to the processing described hereinabove, the I/O scheduler 130 of the computer 100 of this example divides and converts a virtual I/O request issued by the application software 120 to actual I/O requests, carries out I/O scheduling using the properties of the application software 120 the issued the source virtual I/O request and the characteristics of the physical volume of the storage apparatus 300, and issues an actual I/O request 600 directly to the storage apparatus 300 in accordance with the I/O scheduling result.

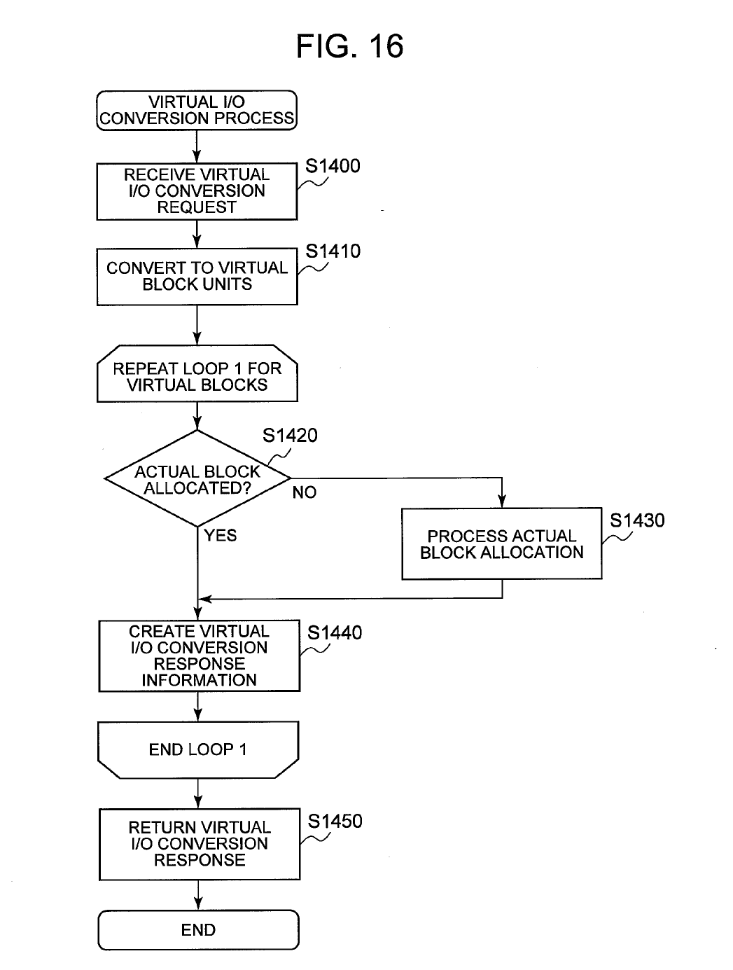

FIG. 16 is a diagram showing a flowchart of a virtual I/O conversion process of the virtualization apparatus 200.

First, the controller 210 of the virtualization apparatus 200 receives a virtual I/O conversion request 510 from the computer 100 (Step S1400).

Next, the controller 210 converts an area specified by the offset and length of the received virtual I/O conversion request 510 to a virtual block unit I/O request, which is the provisioning block size (Step S1410). In a case where the area specified by the virtual I/O conversion request 510 extends beyond the provisioning block boundary, the virtual block unit I/O request is divided into I/O requests relative to multiple virtual blocks at this time.

Next, the controller 210 references the mapping information 223 and determines whether an actual block of the physical volume has already been allocated to each I/O request with respect to the divided virtual block (Step S1420).

In a case where the actual blocks have not been allocated (Step S1420: NO), the controller 210 allocates a new actual block to the virtual volume 330 by referencing the virtual volume configuration information 221 and the physical volume usage status information 224, and adding an unused block of the physical volume configuring the virtual volume 330 to the virtual block number field corresponding to the mapping information 223 (Step S1430). The controller 210 updates both of the virtual volume information 222 and the physical volume usage status information 224 at this time. In a case where there is no unused block in the physical volume configuring the virtual volume 330, the controller 210 sends an error response to the virtualization apparatus 200. At this time, for example, the controller 210 may use the system log and so forth of the virtualization apparatus 200 to notify the administrator of the error caused by the fact that the physical volume area allocated to the virtual volume 330 has been used up. Furthermore, prior to using up all the unused blocks, the controller 210, for example, may notify the administrator in the form of a warning that the number of unused actual blocks is limited at the point in time when the number of unused actual blocks has dropped below 10% of the number of actual blocks allocated to the virtual volume 330. Or, the controller 210 may add an unused physical volume.

In a case where the actual block has been allocated (Step 1420: YES), and after having allocated a new actual block, the controller 210 references the mapping information 223 and the storage apparatus characteristics information 230 and creates virtual I/O conversion response information (Step 1440).

After virtual I/O conversion responses 520 have been created for all of the virtual blocks, the controller 210 collects all of the virtual I/O conversion response information together to make a single virtual I/O conversion response 520, and returns same to the computer 100 (Step S1450).

According to the processing described hereinabove, the controller 210 of the virtualization apparatus 200 receives a virtual I/O conversion request 510 from the computer 100, converts an I/O request with respect to the virtual volume 330 to an I/O request with respect to the physical volume of the corresponding storage apparatus 300, and returns same to the computer 100 as a virtual I/O conversion response 520.

As explained hereinabove, in the computer system of this example, even in a case where the storage area 320 of the storage apparatus 300 has been virtualized as a virtual volume 330 by the virtualization apparatus 200, the I/O scheduler 130 of the computer 100 is able to acquire an area and characteristics information of a physical volume of the corresponding storage apparatus 300, and by carrying out I/O scheduling with respect to the physical volume of the storage apparatus 300, is able to increase the accuracy of this I/O scheduling and enhance the I/O performance of the computer 100.

Because the I/O scheduler 130 of this example is able to make use of the information inside the OS 140, such as the process execution priority and execution filename related to the application software 120, even in a case where the application software 120 clearly does not specify a priority when it issues a virtual I/O request, a priority can be set in accordance with the properties of the application software 120. Furthermore, the I/O scheduler 130 is able to carry out scheduling using the characteristics information of the physical volume of the storage apparatus 300, and in a case where a missed deadline is anticipated, is able to return the virtual I/O request to the application software 120 as an error without issuing the actual I/O request 600, thereby making it possible to prevent a drop in performance as a result of affecting an actual I/O request that has already been executed by the storage apparatus 300.

In addition, the computer 100 of this example issues the actual I/O request 600 directly to the storage apparatus 300, thereby making it possible to prevent the virtualization apparatus 200 from becoming a bottleneck to the execution of an actual I/O.

This example has been explained above, but the present invention is not limited to this embodiment, and can be applied even when various changes have been made.

### Example 2

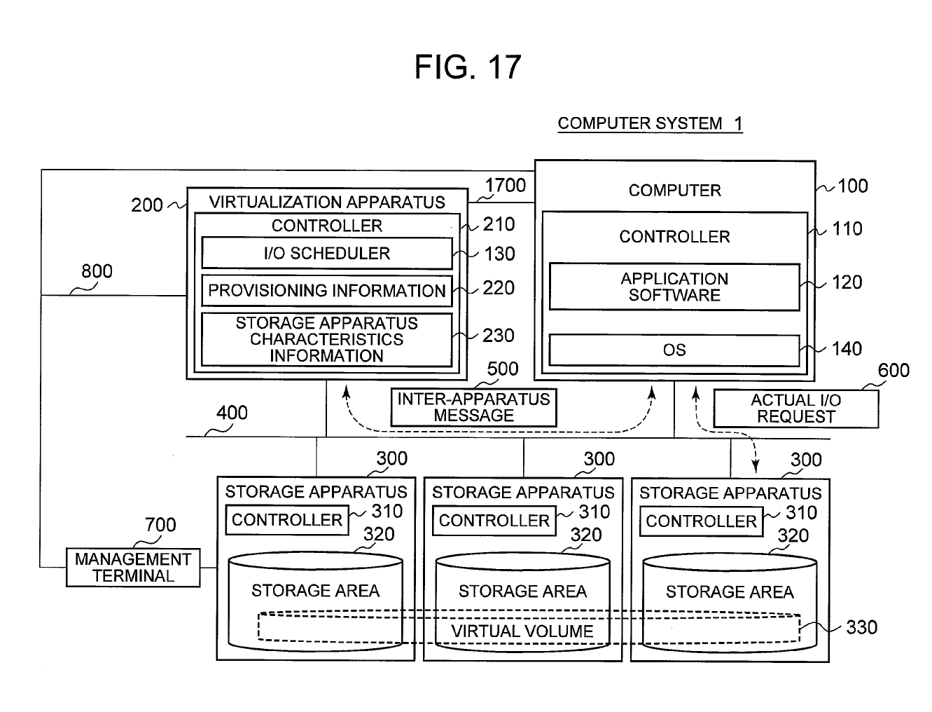

FIG. 17 is a diagram showing the configuration of a computer system of a second example. The point that differs from the first example is that the I/O scheduler 130 is in the virtualization apparatus 200 instead of the computer 100. Otherwise, this example is the same as the first example. The processes in the second example are also the same as those of the first example. However, since the virtual I/O must be sent/received to/from the virtualization apparatus 200, it is necessary to avoid a communications bottleneck. To avoid a bottleneck, a leased line 1700 can be used instead of the network 400. Or, it is also possible to make combined use of both the network 400 and the leased line 1700.

According to the above, in the computer system of this example, even in a case where the storage area 320 of the storage apparatus 300 has been virtualized as a virtual volume 330 by the virtualization apparatus 200, the I/O scheduler 130 of the computer 100 is able to acquire an area and characteristics information of a physical volume of the corresponding storage apparatus 300, and by carrying out I/O scheduling with respect to the physical volume of the storage apparatus 300, is able to increase the accuracy of this I/O scheduling and enhance the I/O performance of the computer 100.

Furthermore, because the I/O scheduler 130 resides in the virtualization apparatus 200, processing is possible even in a case where computer processing speeds are slow.

Furthermore, since the I/O scheduler 130 of this example is able to make use of the information inside the OS 140, such as the application software 120-related process execution priority, the execution filename, and so forth, it is possible to set a priority in accordance with the properties of the application software 120 even in a case where the application software 120 clearly did not specify a priority when it issued the virtual I/O request. Furthermore, the I/O scheduler 130 is able to carry out scheduling using the characteristics information of the physical volume of the storage apparatus 300, and in a case where a missed deadline is anticipated, is able to return the virtual I/O request to the application software 120 as an error without issuing the actual I/O request 600, thereby making it possible to prevent a drop in performance as a result of affecting an actual I/O request that has already been executed by the storage apparatus 300.

### Example 3

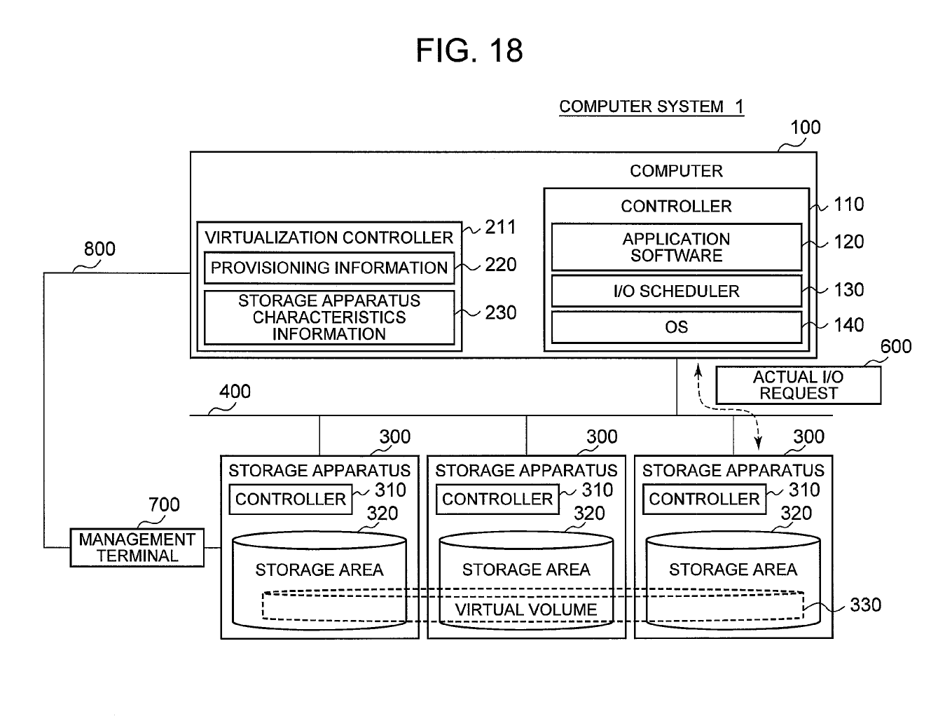

FIG. 18 is a diagram showing the configuration of a computer system of a third example. The difference with the first example and the second example is that instead of having a virtualization apparatus 200, a virtualization controller 211 is disposed inside the computer 100. The processing is the same otherwise, but there are no inter-apparatus messages 500, and processing is carried out solely via the computer 100 internal network.

In the computer system of this example, even in a case where the storage area 320 of the storage apparatus 300 has been virtualized as a virtual volume 330 by the virtualization controller 211, the I/O scheduler 130 of the computer 100 is able to acquire an area and characteristics information of a physical volume of the corresponding storage apparatus 300, and by carrying out I/O scheduling with respect to the physical volume of the storage apparatus 300, is able to increase the accuracy of this I/O scheduling and enhance the I/O performance of the computer 100.

Since the I/O scheduler 130 of this example is able to make use of the information inside the OS 140, such as the application software 120-related process execution priority, the execution filename, and so forth, a priority can be set in accordance with the properties of the application software 120 even in a case where the application software 120 clearly did not specify a priority when it issued the virtual I/O request. Furthermore, the I/O scheduler 130 is able to carry out scheduling using the characteristics information of the physical volume of the storage apparatus 300, and in a case where a missed deadline is anticipated, is able to return the virtual I/O request to the application software 120 as an error without issuing the actual I/O request 600, thereby making it possible to prevent a drop in performance as a result of affecting an actual I/O request that has already been executed by the storage apparatus 300.

In addition, because the computer 100 of this example issues the actual I/O request 600 directly to the storage apparatus 300, it is possible to prevent the virtualization controller 211 from becoming a bottleneck in the execution of the actual I/O.

Furthermore, since there is no need to use an inter-apparatus message, it is possible to conserve the communication bandwidth of the network 400.

Modes for putting the present invention into practice have been explained hereinabove, but the present invention is not limited to this embodiment, and is able to be applied even when various changes are made.

What is claimed is:

1. A computer system for processing data, comprising:
a computer;
multiple storage apparatuses, which are coupled to the computer, and have at least one physical volume; and
a virtualization apparatus for providing the computer with the physical volumes of the multiple storage apparatuses as virtual volumes,
wherein the virtualization apparatus allocates a portion of a storage area of a physical volume corresponding to an input/output (I/O) request sent from the computer,
the computer acquires characteristics information of the physical volume that has been associated with the virtual volume,
the computer divides an I/O request with respect to the virtual volume by storage apparatus in a case where the I/O request spans the multiple storage apparatuses, and
the computer carries out I/O scheduling based on the characteristics information.

2. A computer system according to claim 1, wherein the computer issues an I/O request to each of the physical volumes of the multiple storage apparatuses in accordance with a result of the I/O scheduling.

3. A computer system according to claim 2, wherein the virtualization apparatus comprises provisioning information including information on the correspondence between the virtual volume and the physical volume, and storage apparatus characteristics information including physical volume characteristics information,
the virtualization apparatus converts the I/O request with respect to the virtual volume to an I/O request with respect to an actual storage area of the storage apparatus in accordance with a query from the computer, and
the virtualization apparatus adds an I/O bandwidth, an IOPS, and a delay of the physical volume that is a target of the converted I/O request, as storage apparatus characteristics information, and responds to the computer.

4. A computer system according to claim 3, wherein the computer uses an execution priority and an execution filename inside an OS of the computer to determine respective I/O priorities of multiple I/O requests, and carries out I/O scheduling based on the I/O priorities together with actual storage area characteristics information.

5. A computer system according to claim 4, wherein the computer carries out I/O scheduling based on the characteristics information and a deadline stipulated by an application software, and
carries out an error response in a case where a missed deadline occurs.

6. A computer system according to claim 4, wherein the computer issues the multiple actual I/O requests to the storage apparatus on the basis of the virtual I/O request, receives results of the multiple actual I/O requests from the storage apparatus, reconfigures a result of the virtual I/O request based on the results of the multiple I/O requests, and responds to the computer.

7. An input/output method of a computer system which processes data and includes a computer, multiple storage apparatuses coupled to the computer and having at least one physical volume, and a virtualization apparatus for providing the computer with the physical volumes of the multiple storage apparatuses as virtual volumes, the input/output method comprising the steps of:
allocating, by the virtualization apparatus, a portion of a storage area of a physical volume corresponding to an input/output (I/O) request sent from the computer;
acquiring, by the computer, characteristics information of the physical volume that has been associated with the virtual volume;
dividing, by the computer, an I/O request with respect to the virtual volume by storage apparatus in a case where the I/O request spans the multiple storage apparatuses; and
carrying out, by the computer, I/O scheduling based on the characteristics information.

8. A computer system input/output method according to claim 7, wherein the computer issues an I/O request to each of the physical volumes of the multiple storage apparatuses in accordance with a result of the I/O scheduling.

9. A computer system input/output method according to claim 8, wherein the virtualization apparatus comprises provisioning information including information on the correspondence between the virtual volume and the physical volume, and storage apparatus characteristics information including physical volume characteristics information,
the virtualization apparatus converts the I/O request with respect to the virtual volume to an I/O request with respect to an actual storage area of the storage apparatus in accordance with a query from the computer, and
the virtualization apparatus adds an I/O bandwidth, an IOPS, and a delay of the physical volume that is a target of the converted I/O request, as storage apparatus characteristics information, and responds to the computer.

10. A computer system input/output method according to claim 9, wherein the computer uses an execution priority and an execution filename inside an OS of the computer to determine respective I/O priorities of multiple I/O requests, and carries out I/O scheduling based on the I/O priorities together with actual storage area characteristics information.

11. A computer system input/output method according to claim 10, wherein the computer carries out I/O scheduling based on the characteristics information and a deadline stipulated by an application software, and
carries out an error response in a case where a missed deadline occurs.

12. A computer system input/output method according to claim 10, wherein the computer issues the multiple actual I/O requests to the storage apparatus on the basis of the virtual I/O request, receives results of the multiple actual I/O requests from the storage apparatus, reconfigures a result of the virtual I/O request based on the results of the multiple I/O requests, and responds to the computer.
